(19) United States
(12) Patent Application Publication
(10) Pub. No.: US 2006/0212824 A1
(43) Pub. Date: Sep. 21, 2006

(54) Methods for navigating through an assembled object and software for implementing the same

(76) Inventor: Anders Edenbrandt, Lund (SE)

Correspondence Address: HARNESS, DICKEY & PIERCE, P.L.C., P.O. BOX 8910, RESTON, VA, 20195, US

(21) Appl. No.: 11/079,874

(22) Filed: Mar. 15, 2005

(51) Int. Cl. G06F 9/00

(52) U.S. Cl. 715/788; 715/854; 715/804; 715/802

(57) ABSTRACT

Methods for navigating through an assembled object, for example, a web-page, and HTML document, etc. The assembled object may include any suitable number of geometrical objects, which may have an arbitrary shape and/or be arbitrarily situated within, for example, a two dimensional or three dimensional area.

The present invention relates to navigating through an assembled object, for example, a web-page, a Hyper Text Mark-up Language (HTML) document, etc.

### BACKGROUND OF THE INVENTION

In conventional navigation methods, navigation may be executed according to a fixed scheme, or based on geometrical distances between geometrical objects. The geometrical distances between geometrical objects may be used to determine which geometrical object to shift focus to in response to a received directional command. The geometrical distances may be measured in a direction corresponding to the received directional command. However, in more complicated assembled objects, a user may not be able to reach all geometrical objects within the assembled object.

FIG. 1 illustrates an example of an assembled object 19. The assembled object 19 may include, for example, nine geometrical objects, 1, 3, 5, 7, 9, 11, 13, 15, and 17. An example of conventional navigational behavior is illustrated with respect to the assembled object 39 of FIG. 2. For each of the geometrical objects 21, 23, 25, 27, 29, 31, 33, 35, and 37, arrows describing the possible movements of focus are shown. As illustrated in FIG. 2, using conventional navigation methods, a user may not be able to reach all of the geometrical objects within an assembled object. For example, if object 29 is chosen as a starting object, after leaving object 29, the user may not return to object 29.

### SUMMARY OF THE INVENTION

In an example embodiment of the present invention, at least one object within an assembled object may be identified, a grid including at least one may be generated, and at least one of the at least one pane may include at least a portion of one of the at least one identified object. Location information associated with at least one of the at least one identified object or the grid may be stored and the assembled object may be navigated through based on the stored location information.

Another example embodiment of the present invention may provide a web-browser adapted to perform a method for navigating through an assembled object according to an example embodiment of the present invention. In an example embodiment of the present invention, the web-browser may be adapted to identify at least one object within the assembled object and generate a grid including at least one pane, which may include at least a portion of the at least one identified object. Location information associated with the at least one identified object or the grid may be stored and the assembled object may be navigated through based on the stored location information.

Another example embodiment of the present invention may provide a web-browser adapted to perform a method for navigating through an assembled object according to another example embodiment of the present invention. In an example embodiment of the present invention, the web-browser may be adapted to identify at least one object within the assembled object and replace at least one of the at least one identified object with a geometrical representation. A grid may be generated including at least one pane, which may include at least a portion of one of the at least one geometrical representation. Location information associated with at least one of the at least one geometrical representation or the grid may be stored and the assembled object may be navigated through based on the stored location information.

Another example embodiment of the present invention may provide a program storage device readable by a machine, and tangibly embodying a program of instructions executable by the machine to perform a method for navigating through an assembled object according to an example embodiment of the present invention. In an example embodiment of the present invention, the program may be adapted to identify at least one object within the assembled object and generate a grid including at least one pane, which may include at least a portion of at least one of the at least one identified object. Location information associated with at least one of the at least one identified object or the grid may be stored and the assembled object may be navigated through based on the stored location information.

Another example embodiment of the present invention may provide a program storage device readable by a machine, and tangibly embodying a program of instructions executable by the machine to perform a method for navigating through an assembled object according to another example embodiment of the present invention. In an example embodiment of the present invention, the program may be adapted to identify at least one object within the assembled object and replace at least one of the at least one identified object with a geometrical representation. A grid may be generated including at least one pane in which at least one of the at least one pane may include at least a portion of one of the at least one geometrical representation. Location information associated with at least one of the at least one geometrical representation or the grid may be stored and the assembled object may be navigated through based on the stored location information.

In example embodiments of the present invention, the generation of the grid may further include generating and sequencing object rectangle lines based on locations of the identified object(s); and selecting grid lines for the grid from the object rectangle lines based on the sequence of the object rectangle lines.

In example embodiments of the present invention, the sequence of object rectangle lines may include a sequence of vertical object rectangle lines and a sequence of horizontal object rectangle lines.

In example embodiments of the present invention the navigation through the assembled object may further include selecting a pane, receiving a command and performing a designated operation based on the received command.

In example embodiments of the present invention, the designated operation may be at least one of shifting to another assembled object and shifting to another generated pane including an object within the assembled object.

In example embodiments of the present invention, the received command may be a directional command and the performing of the designated operation may be shifting focus to another generated pane.

In example embodiments of the present invention, the designated operation may further include choosing a second generated pane to shift to based on at least one of stored location information, a previously visited pane, and a designated default directional movement.

In example embodiments of the present invention, the assembled object may be a web-page or Hyper Text Mark-up Language (HTML) document.

In example embodiments of the present invention, the location information associated with the identified object(s) may include coordinate information for at least a portion of each of the identified object(s) within the assembled object.

In example embodiments of the present invention, the location information associated with the generated pane(s) of the grid may include a list of at least a portion of the generated pane(s) in the grid and an indication of the presence or absence of an identified object within each generated pane included in the list.

In example embodiments of the present invention, the location information associated with the geometrical representation(s) may include coordinate information for at least a portion of each of the geometrical representation(s).

In example embodiments of the present invention, the location information associated with the generated pane(s) of the grid may include a list of at least a portion of the generated pane(s) in the grid and an indication of the presence or absence of a geometrical representation(s) within each generated pane included in the list.

In example embodiments of the present invention, the at least one identified object, which may be replaced, may be a non-rectangular object.

In example embodiments of the present invention, the geometrical representation may be an object rectangle.

### BRIEF DESCRIPTION OF THE DRAWINGS

Example embodiments of the present invention will become more fully understood from the detailed description given herein below and the accompanying drawings, wherein like elements are represented by like reference numerals, which are given by way of illustration only and thus are not limiting of the present invention and wherein:

FIG. 1 illustrates an example of an assembled object;

FIG. 2 illustrates an example of navigation movements according to a conventional navigation method;

FIG. 3 is a flow chart illustrating a method for navigating through an assembled object, according to an example embodiment of the present invention;

FIG. 4 illustrates a method for generating a grid, according to an example embodiment of the present invention;

FIG. 4a illustrates an example of an assembled object, which may be navigated using example embodiments of the present invention;

FIG. 4b illustrates an example of rectangular hulls, which may be generated according to example embodiments of the present invention;

FIG. 4c illustrates an example of a modified assembled object, which may include object rectangle lines, object rectangles, and selected grid lines, according to example embodiments of the present invention;

FIG. 4d is a flow chart illustrating a method for generating grid lines, according to an example embodiment of the present invention;

FIG. 5 illustrates a method for storing location information, according to an example embodiment of the present invention;

FIG. 6 illustrates a method for navigating, according to an example embodiment of the present invention;

FIG. 7 illustrates an example of navigational behavior, based on an example embodiment of the present invention; and

FIG. 8 illustrates another example of navigational behavior, based on an example embodiment of the present invention.

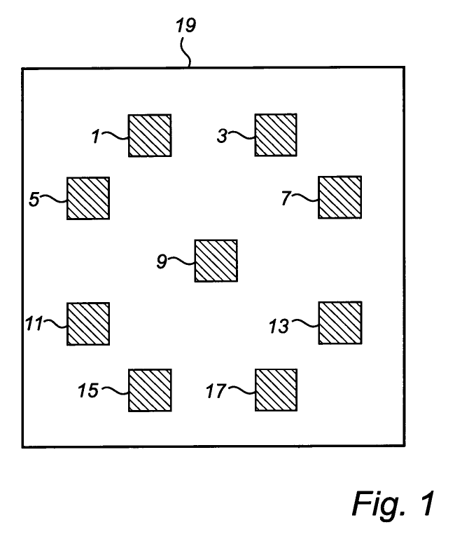

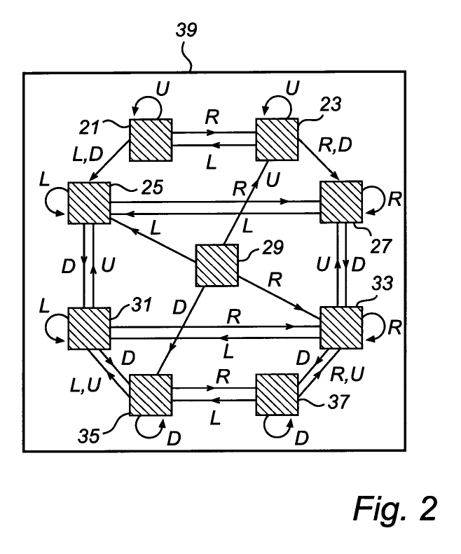

### DETAILED DESCRIPTION OF THE EXAMPLE EMBODIMENTS OF THE PRESENT INVENTION

Example embodiments of the present invention may provide methods, apparatuses, software applications, web-browsers, and computer readable medium for navigating through an assembled object, for example, an HTML document or web-page.

Example embodiments of the present invention provide new methods for navigating between at least one geometrical object, which may be located in an assembled object. An assembled object (e.g., a web-page, HTML document, etc.) may include any suitable number of geometrical objects, which may have an arbitrary shape and/or be arbitrarily situated within, for example, a two dimensional or three dimensional area. Example embodiments of the present invention, however, will be described with respect to two dimensions.

For example, the assembled object may be a web-page or Hypertext Mark-up Language (HTML) document and the geometrical objects may be one or more hyper-links or hypertext anchors, which may also be referred to as hot links or hot spots. Each hyper-link may be associated with a Uniform Resource Locator (URL), which may lead to another assembled object. Example embodiments of methods for navigating may be performed using directional commands, which may correspond to, for example, four directions (e.g., left, right, up, and down), although any suitable number of directions may be used.

Example embodiments of the present invention provide a navigation method, which may include generating a grid corresponding to at least a part of the assembled object. In an example embodiment of the present invention, navigation between geometrical objects in an assembled object may be performed by a navigating through a hidden grid, for example, based on a set of decision rules.

In example embodiments of the present invention, the grid (e.g., hidden grid) may include one or more columns (vertical) and rows (horizontal), which may be variable in width and/or height. The columns and rows may intersect in order to create panes, and the one or more panes may constitute the grid.

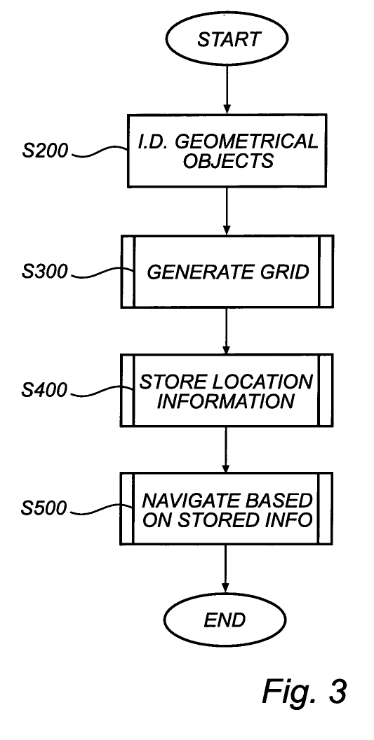

FIG. 3 is a flow chart illustrating a method for navigating through an assembled object, according to an example embodiment of the present invention. In the example embodiment shown in FIG. 3, an assembled object (e.g., an HTML document or web-page) may be loaded and geometrical objects included in the assembled object may be identified at S200. For example, an assembled object (e.g., an HTML document or web-page) may include text, images, and/or sound inserted therein and/or be linked to another assembled object. Further, positions (e.g., a hypertext anchor, an image map, an image map containing hypertext anchors, etc.) within an assembled object may allow a jump from a position to a linked position in the same assembled object, and/or may allow various files and/or documents (including, for example, multi-media files, interactive web-pages, etc.) to be read or browsed more easily. Further, upon selection of a hot spot, a window for transmitting electronic mail and/or a window for starting a specific function related to the hot spot or link may be opened. By linking hot spots to various items in an assembled object in advance, a user may browse assembled objects (e.g., HTML documents) or execute various functions associated with the hot spots.

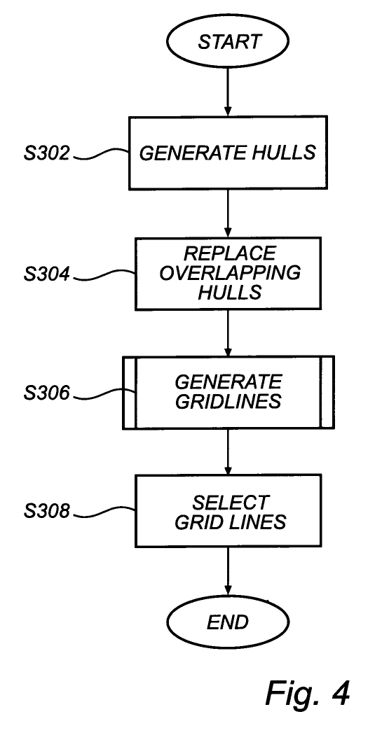

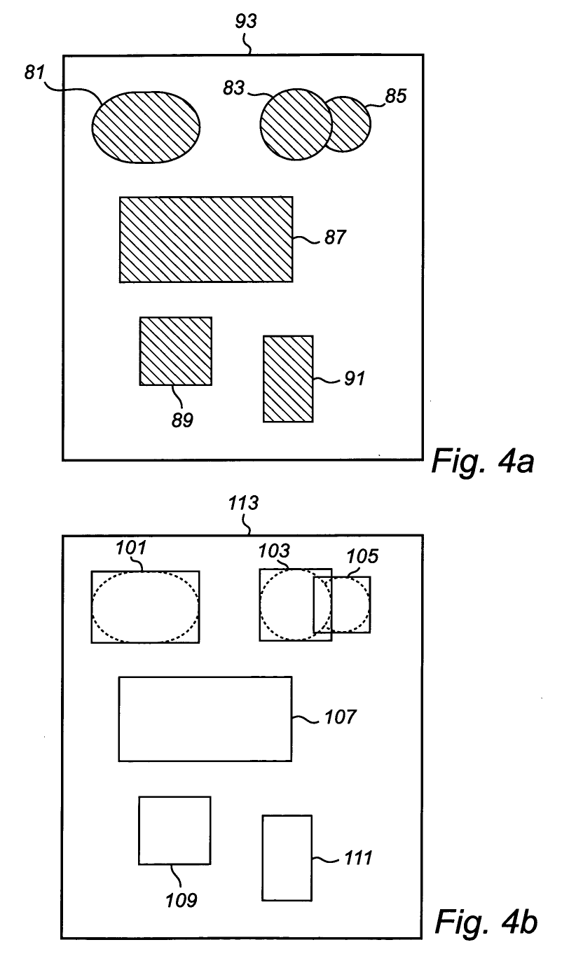

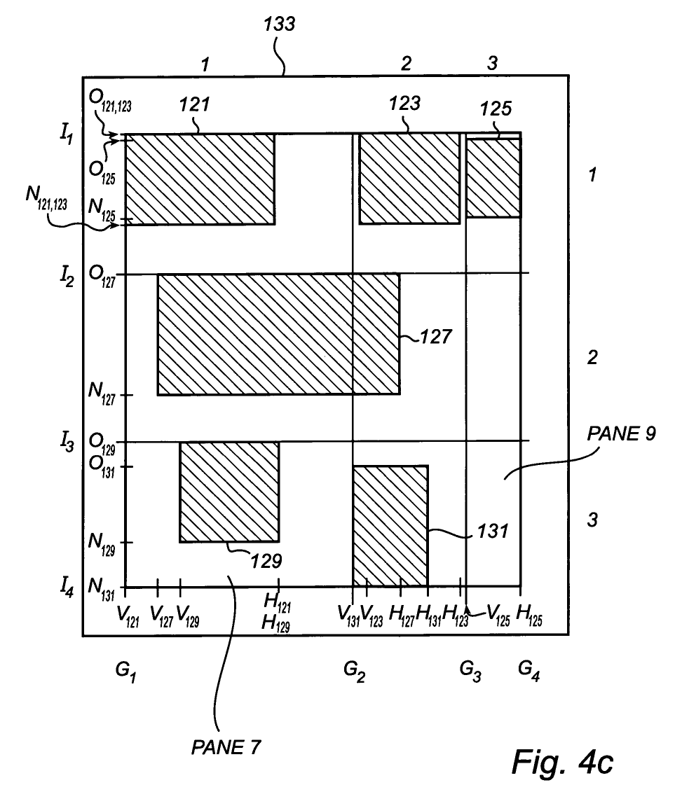

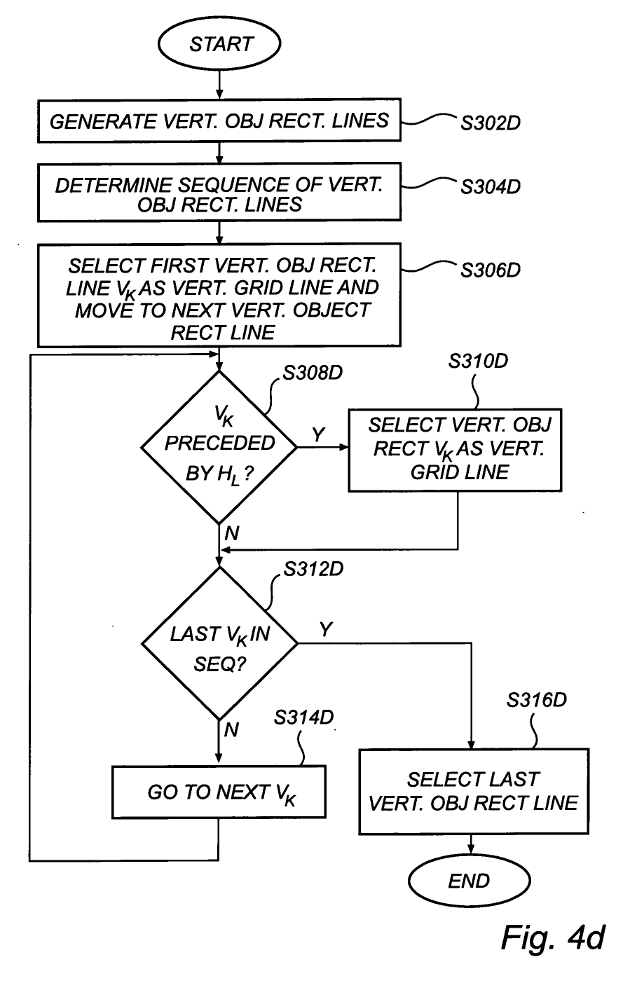

Returning to FIG. 3, at S300, a grid, which may include one or more panes, may be generated. The grid may be generated such that at least one of the panes may include at least a portion of a geometrical object. The panes may be formed by intersecting rows and columns. Although a grid, as discussed herein, includes a one or more rows and columns, in the alternative, the grid may include rows or columns. That is, for example, a collection of rows or columns may constitute a grid, which may provide one-dimensional navigation. Generating a grid, according to example embodiments of the present invention will be described in more detail below with regard to FIGS. 4, 4a, 4b, 4c, and 4d.

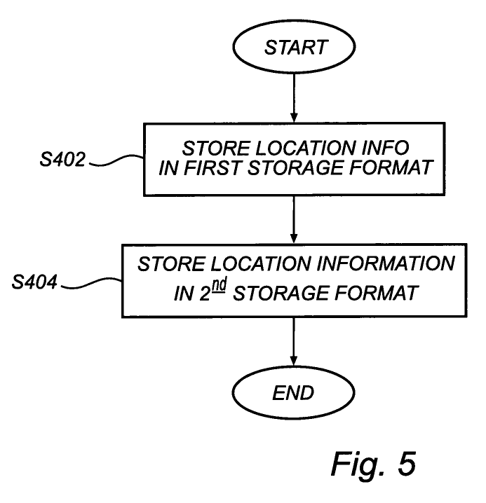

At S400, location information associated with at least one of the geometrical objects and the panes of the grid may be stored in a storage medium, for example, random access memory (RAM), FLASH memory, a database, a CD-ROM, a hard drive, or any other suitable storage medium or memory device. Storing location information, according to example embodiments of the present invention will be described in more detail below with regard to FIG. 5.

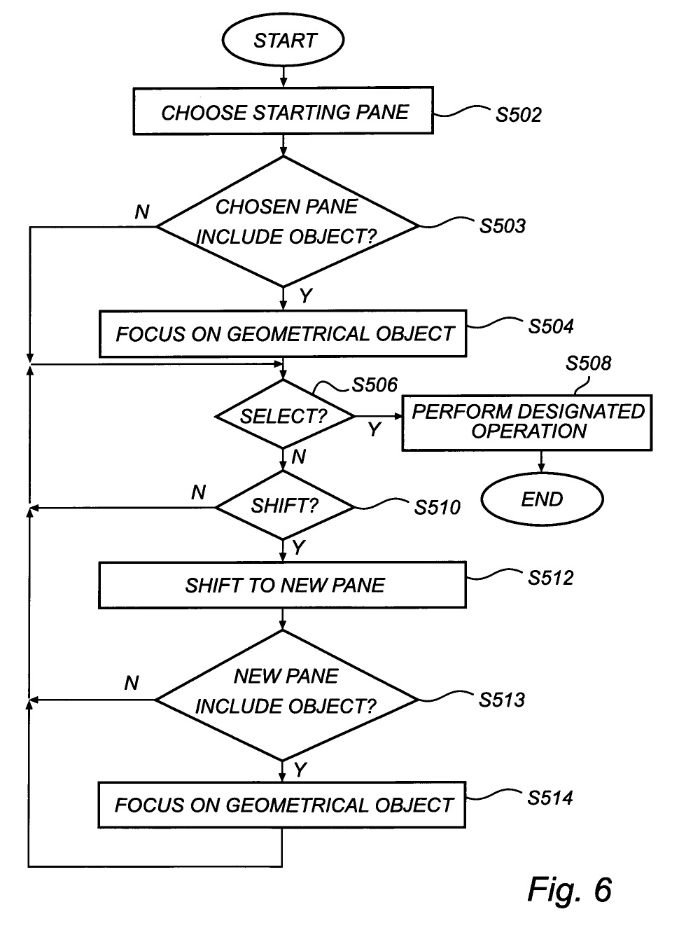

At S500, a user may navigate between geometrical objects using, for example, directional commands left, right, down, and up (e.g., denoted L, R, D, U, respectively), originating from, for example, directional buttons (e.g., a keypad) on a suitable device. The suitable device may be, for example, a mobile phone, a personal digital assistant (PDA), etc. Navigating through an assembled object, according to example embodiments of the present invention, will be described in more detail below with regard to FIG. 6.

FIG. 4 is a flow chart illustrating a method for generating a grid (e.g., a hidden grid), according to an example embodiment of the present invention. FIG. 4a illustrates an example of an assembled object 93, for which a grid, may be generated. FIG. 4b illustrates an example of rectangular hulls, which may be generated for each of the geometrical objects 81, 83, 85, 87, 89, and 91 in the assembled object 93.

At S302, rectangular hulls 101, 103, 105, 107, 109, and 111 (as shown in FIG. 4b) may be generated for all, or substantially all, of the geometrical objects 81, 83, 85, 87, 89, and 91, respectively, in the assembled object 93, of FIG. 4a. Each rectangular hull 101, 103, 105, 107, 109, and 111, of FIG. 4b, may be generated such that each may include one of the geometrical objects 81, 83, 85, 87, 89, and 91, respectively, as a whole. For example, each generated rectangular hull 101, 103, 105, 107, 109, and 111 may have the minimum area required to include each of the geometrical objects 81, 83, 85, 87, 89, and 91, respectively, in their entirety.

For example, for non-rectangular geometrical object 81, a rectangular hull 101 may be generated and the rectangular hull may have a size (e.g., the smallest size measured by area), which includes the non-rectangular geometrical object 81 as a whole. For example, as shown in FIG. 4b, if the geometrical object 81 is circular in shape, the rectangular hull 101 may be generated such that each edge of the rectangular hull 101 may be tangential to a point on the edge of the geometrical object 81. Alternatively, however, the geometrical objects may be any shape.

In another example, if the geometrical objects are rectangular in shape (e.g., 87, 89, and 91), corresponding rectangular hulls (e.g., 107, 109, and 111) may be generated, for example, by copying the geometrical objects 87, 89, and 91, or, for example, the rectangular hulls may be generated based on the geometry (e.g., using the perimeter) of the geometrical objects 87, 89, and 91, respectively.

Returning to FIG. 4, at S304, if the modified assembled object 113 includes rectangular hulls, which geometrically overlap (e.g., 103 and 105, which may occur for geometrical objects contained in image maps), the rectangular hulls 103 and 105 may replaced by non-overlapping object rectangles 123 and 125, respectively, as shown in FIG. 4c. The object rectangles may be positioned to resemble the positioning of corresponding geometrical objects, which may provide a user with a more natural looking navigation. Algorithms for small changes may be well-known to the skilled artisan, and thus will be omitted.

Referring again to FIG. 4, at S306, vertical object rectangle lines may be generated (or identified) based on the object rectangles 121, 123, 125, 127, 129, and 131 included in the modified assembled object, illustrated in FIG. 4c. The object rectangles 121, 123, 125, 127, 129, and 131 may represent the geometrical objects 81, 83, 85, 87, 89, and 91, illustrated in FIG. 4a. Methods for generating vertical object rectangle lines, according to example embodiments of the present invention, will be described in more detail below with regard to FIG. 4c. At S308, vertical grid lines may be selected from the generated (or identified) vertical object rectangle lines.

As discussed above, FIG. 4c illustrates an example modified assembled object 133, which may include object rectangles 121, 123, 125, 127, 129, and 131. An example method for generating a grid, according to an example embodiment of the present invention, will now be discussed with respect to FIG. 4c.

In a method for generating grid lines, according to an example embodiment of the present invention, a sequence of vertical grid lines Gₘ (where m may represent the number of the vertical gridline from left to right) may be selected from a set of vertical object rectangle lines Vₖ and Hₗ (where k and l may represent object rectangles in the modified assembled object 133), which may be generated based on the horizontal position of the object rectangles 121 -131. For example, vertical object rectangle lines Vₖ and Hₗ may be generated for each left edge and each right edge of the object rectangles 121, 123, 125, 127, 129, and 131, as shown in FIG. 4c. For illustration purposes, Vₖ may represent a left edge of an object rectangle, and Hₗ may represent a right edge of an object rectangle.

The vertical grid lines Gₘ (where m may represent the number of the vertical gridline from left to right) may be chosen based on the sequence of vertical object rectangle lines Vₖ and Hₗ. For example, consecutive vertical grid lines Gₘ and Gₘ₊ₗ may be chosen such that at least one consecutive Vₖ and Hₗ (i.e., at least one Vₖ immediately followed by an Hₗ) is included there between. The last vertical object rectangle line Vₖ or Hₗ may then be selected as a vertical gridline.

For example, with regard to FIG. 4c, from left to right, the vertical object rectangle lines have a sequence V₁₂₁, V₁₂₇, V₁₂₉, H_{121, 129}, V₁₃₁, V₁₂₃, H₁₂₇, H₁₃₁, H₁₂₃, V₁₂₅, H₁₂₅. The sequence includes two completed and one non-completed period of V . . . H . . . V. That is, the sequence above includes two completed periods (e.g., V₁₂₁, V₁₂₇, V₁₂₉, H_{121, 129}, V₁₃₁ and V₁₃₁, V₁₂₃, H₁₂₇, H₁₃₁, H₁₂₃, V₁₂₅), and one incomplete period (e.g., V₁₂₅, H₁₂₅). Accordingly, the vertical object rectangle lines V₁₂₁, V₁₃₁, and V₁₂₅ may be chosen as vertical gridlines G₁, G₂, G₃, respectively, a vertical grid line G₄, may then be added at the horizontal position of the last Hₗ (e.g., H₁₂₅).

Another method for generating grid lines, according to an example embodiment of the present invention, is illustrated in FIG. 4d. In the example embodiment as illustrated in FIG. 4d, vertical grid lines G₁, G₂, G₃, and G₄ may be selected based on the sequence of the vertical object rectangle lines Vₖ and Hₗ. For illustration purposes, this example embodiment will also be discussed with regard to FIG. 4c.

Referring to FIG. 4d, similar to that as discussed above with regard to FIG. 4c, at S302D, vertical object rectangle lines Vₖ and Hₗ may be generated (or identified) for each left edge and each right edge of the object rectangles 121, 123, 125, 127, 129, and 131. At S304D, the vertical object rectangle lines Vₖ and Hₗ may have a sequence based on their respective horizontal position in the grid. For example, the vertical object rectangle lines may have the sequence V₁₂₁, V₁₂₇, V₁₂₉, H_{121, 129}, V₁₃₁, V₁₂₃, H₁₂₇, H₁₃₁, H₁₂₃, V₁₂₅, H₁₂₅ as shown in FIG. 4c.

At S306D, the vertical object rectangle line at the first horizontal position, for example, from left to right (e.g., V₁₂₁ in FIG. 4c) may be selected as a vertical grid line Gₘ (where m may represent the number of the vertical gridline from left to right), and the next vertical object rectangle line V₁₂₇ may be examined. At S308D, if the subsequent vertical object rectangle line Vₖ is immediately preceded by a vertical object rectangle line Hₗ, a vertical grid line Gₘ₊ₗ may be added at the horizontal position of the subsequent vertical object rectangle line Vₖ, at S310D.

At S312D, a determination is made as to whether there are any vertical object rectangle lines Vₖ remaining in the sequence. If there are no remaining vertical object rectangle lines Vₖ, a vertical grid line Gₘ may be added at the horizontal position of the last vertical object rectangle line Vₖ or Hₗ, at S316D.

Returning to step S312D, if vertical object rectangle lines Vₖ remain in the sequence, the next vertical object rectangle line Vₖ may be examined, at S314D, and the process may return to S308D.

Returning to S308D, if it is determined that the currently examined vertical object rectangle line Vₖ is not immediately preceded by a vertical object rectangle line Hₗ, the method may determine if there are any remaining vertical object rectangle lines Vₖ in the sequence, at S312D. The process may then proceed from S312D, as discussed above.

Referring again to FIG. 4c, a set of horizontal grid lines I_{b} (e.g., I₁, I₂, I₃, and I₄) may be chosen from a sequence of horizontal object rectangle lines Oᵤ and Nᵥ in a similar, or substantially similar, manner as described above with regard to the vertical grid lines G₁, G₂, G₃, and G₄. That is, the horizontal object rectangle lines Oᵤ may be analogous to the vertical object rectangle lines Vₖ, and the horizontal object rectangle lines Nᵥ may be analogous to the vertical object rectangle lines H₁.

Thus, the modified assembled object 133, as illustrated in FIG. 4c, may be divided into a grid, which may include vertical grid lines G₁, G₂, G₃, and G₄ and horizontal grid lines I₁, I₂, I₃, and I₄. The vertical and horizontal grid lines may be created independently of one another, in an arbitrary order and/or simultaneously.

Although example embodiments have been described with regard to grid lines Gₘ being set at horizontal positions of vertical object rectangle lines Vₖ and Hₗ and grid lines I_{b} being set at vertical positions of horizontal rectangle object lines Oᵤ and Nᵥ, it will be understood that grid lines may not be set at the precise positions of the corresponding Vₖ, Hₗ, Oᵤ, or Nᵥ.

For example, the first vertical grid line G1 may be placed anywhere to the left of the first Vₖ and/or the first horizontal gridline Iₗ may be placed anywhere above the first horizontal object rectangle line Oᵤ. Similarly, the final vertical grid line G₄ may be placed anywhere to the right of the last vertical object rectangle line Vₖ or Hₗ and the last horizontal grid line 14 may be placed anywhere below the last horizontal object rectangle line Oᵤ or Nᵥ. For the grid lines G2 and G₃ and I₂ and I₃ added in between, possible placements may be anywhere between consecutive vertical object rectangle lines Vₖ and Hₗ or horizontal object rectangle lines Oᵤ and Nᵥ.

Although example embodiments of methods for generating a grid have been discussed with respect to geometrical objects, which are non-rectangular in shape and overlapping, it will be understood that if all the geometrical objects may be rectangular in shape and non-overlapping, the method may omit S302, and S304. Subsequently, the method according to another example embodiment, may generate vertical and horizontal object rectangle lines at S306, and select vertical and horizontal grid lines at S308.

FIG. 5 illustrates a method for storing location information, according to an example embodiment of the present invention. With regard to FIG. 5, at S402, location information may be stored in a first storage format. The first storage format may include, for example, a list of all, or substantially all, object rectangles and corresponding coordinates for locating the object rectangles in the grid. For example, the first storage format may include coordinates for an upper left corner of each of the object rectangles present (e.g., each of the object rectangles representing a geometrical object displayable to the user) in the modified assembled object. The coordinates may be represented by column number and row number with respect to the grid. The list may also include references to information regarding a geometrical object corresponding to each of the object rectangles in the list. The corresponding geometrical objects may be used for updating the rendering of the assembled object, for example, when focus is shifted between panes.

The column numbers and row numbers may be numbered from top to bottom and from left to right. For example, in FIG. 4c, the object rectangle 129 may be situated in row 3, column 1.

At S404, information may be stored in a second storage format. The second storage format may include a list of all, or substantially all, panes in the grid. For example, the list may include numbers (e.g., 1, 2, 3, . . . , N) corresponding to each pane in the grid, and the numbers may be assigned, for example, according to a row-wise system from left to right and top to bottom. The list may also include, for example, information regarding which object rectangle (or portion of an object rectangle) exists in each pane. For example, in FIG. 4c, pane number 7 may include the object rectangle 129, however, pane number 9 may not include an object rectangle.

FIG. 6 is a flow chart illustrating a method for navigating through an assembled object, according to an example embodiment of the present invention. Referring to FIG. 6, at S502, a user may choose a starting pane, which may or may not include an object rectangle, for example, using a web browser, or any other suitable mechanism. At S503, if the chosen starting pane includes at least a portion of an object rectangle, the corresponding geometrical object may be shown to the user, at S504.

At S506, a determination may be made as to whether a selection command has been received, for example, from a user. If a selection command has been received, the corresponding geometrical object within the focused pane may be selected for a further operation, at S508. For example, a selection command may be a jump to a linked position or location, initiation of a new window for transmitting electronic mail, initiation of new window for starting a function related to the geometrical object, an/or any other suitable operation.

Returning to S506, if a selection command has not been received, a determination may be made as to whether a directional command has been received, at S510. If a directional command has not been received, the procedure may return to S506.

Returning to S510, if a directional command has been received, the focus may shift to a new pane, at S512. A determination may then be made, at S513, as to whether the new pane includes at least a portion of an object rectangle. If the new pane does not include at least a portion of an object rectangle the procedure may return to S506.

Returning to S513, if the new pane does include at least a portion of an object rectangle, the geometrical object represented by the object rectangle may be shown to the user, at S514, and the procedure may return to S506.

Returning to S503, if the chosen starting pane does not include at least a portion of an object rectangle, the method may proceed to S506.

In example embodiments of the navigation method, according to the present invention, focus may be shifted between panes based upon decision rules.

Decision rules for navigating to the left and to the right, according to an example embodiment of the present invention, may be performed as follows. The closest pane in the requested direction (e.g., left or right), including at least a portion of an object rectangle, and in the same row in the grid (as the pane currently in focus) may be chosen. If no such pane exists in the requested direction, focus may not be shifted or focus may be shifted to the first suitable pane after a wrap around of the row. While searching for a suitable pane to shift focus to, information stored according to the second storage format may be used.

Similarly, decision rules for navigating up and down, according to an example embodiment of the present invention, may be performed as follows. A pane in a next row in the requested direction, including at least a portion of an object rectangle and with the smallest horizontal deviation measured from the pane in focus may be chosen. If there are two panes, which have equally small deviations, the pane with the smaller deviation from the most recently visited pane may be chosen. If the deviations from the most recently visited pane are equal, the method may, for example, choose the pane in a designed default direction (e.g., to the left, to the right, up, down, etc.).

Deviation between panes may be measured, for example, using a difference in column or row numbers, but may also be measured using a geometrical distance in the rendered image shown to the user.

In the navigation method, according to example embodiments of the present invention, the state of the navigation may not be the geometrical object of focus, but the number of the pane in focus together with previously visited pane numbers. Accordingly, panes and numbers associated therewith may be used in conjunction with decision rules while navigating through object rectangles that exist in more than one pane.

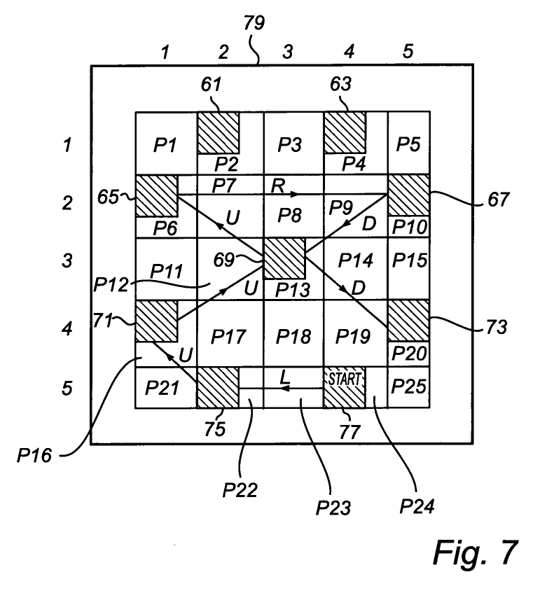

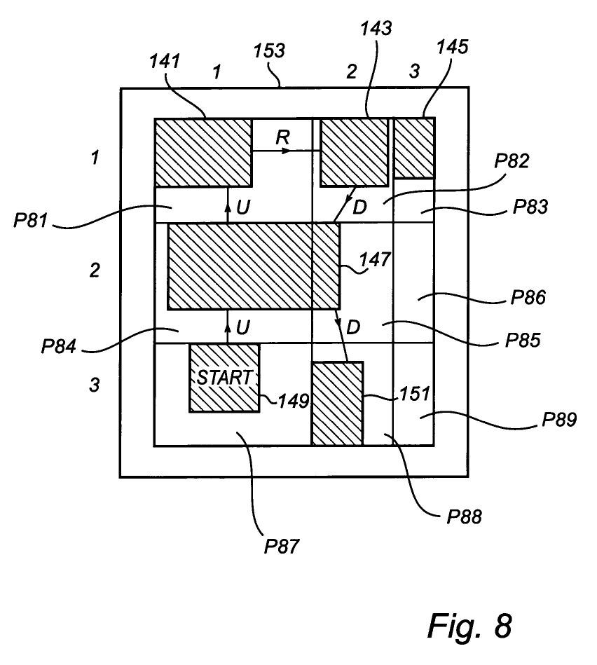

For illustration purposes, examples of the decision rules will be described with regard to FIGS. 7 and 8, however, it will be understood that the decision rules as described herein may be applied to any assembled object (or modified assembled object), for example, more complex assembled objects (or modified assembled objects). Further, for illustration purposes, the columns of FIG. 7 and FIG. 8 are labeled 1-5 and 1-3, respectively, (numbered from left to right) and the rows of FIG. 7 and FIG. 8 are labeled 1-5 and 1-3, respectively (numbered from top to bottom). Also for illustration purposes, in FIG. 7, the panes have been labeled P1-P25 (from left to right and top to bottom) and the panes in FIG. 8 have been labeled P81-P89 (from left to right and top to bottom).

FIG. 7 illustrates an example of navigational behavior based on an example embodiment of the present invention. In FIG. 7, a user may begin the navigation with pane P24 including object rectangle 77 (denoted “START”), and the user may be shown geometrical object 17 as being focused. A first directional command L may shift focus to pane P22 including object rectangle 75, and the user may be shown geometrical object 15. A second directional command U may shift focus to pane P16 including object rectangle 71, and another U may shift focus to pane P13 including object rectangle 69. As illustrated in FIG. 7, there may be two panes P6 and P10 including two object rectangles 65 and 67, respectively, in the row directly above pane P13 including object rectangle 69. The two panes P6 and P10 may have the same horizontal deviation measured from current pane P13 of focus. Accordingly, the smaller horizontal deviation measured from the most recently visited pane P16 may be used for the decision as to which pane may be selected, and the focus may shift to pane P6.

After further commands and corresponding shifts the navigation may return to pane P13. Similar to that as discussed above, panes P16 and P20 (including object rectangles 71 and 73, respectively) may have the same horizontal deviation measured from the current pane P13 of focus. If the directional command D is received, for example, from a user via a web-browser, the horizontal deviation measured from each of panes P16 and P20 to the most recently visited pane P10 may be used for deciding to which pane to shift focus. Subsequently, similar to that as discussed above, focus may shift to the pane P20.

Navigation may depend on where focus is placed (e.g., in which pane) in a new document and/or where focus is placed when the user has scrolled to a new part of an assembled object, for example, an empty pane (i.e., a pane, which does not include at least a portion of an object rectangle).

In order to make the navigation look natural (e.g., smooth) from the user's point of view, the object rectangles may be situated such that they may resemble corresponding original geometrical objects. Algorithms for small changes may be well-known to the skilled artisan, and thus will be omitted.

FIG. 8 illustrates another example of navigating through an assembled object using a modified assembled object 153 and the decision rules, according to an example embodiment of the present invention. As shown in FIG. 8 a user may start with pane P87 in focus. Pane P87 may include the object rectangle 149 (denoted “START”), which corresponds to the geometrical object 89. A first directional command U may shift focus to pane P84, which includes a portion of the object rectangle 147, and the user may be shown corresponding geometrical object 87. A second directional command U may shift focus to pane P81, which includes the object rectangle 141, and the user may be shown corresponding geometrical object 81. An R directional command may shift focus to pane P82, which includes the object rectangle 143, and the user may be shown geometrical object 83. A D may shift focus to pane P85, which includes another portion of the object rectangle 147, and the user may again be shown geometrical object 87. Another D directional command may shift focus to pane 151, which includes object rectangle 151, and the user may be shown geometrical object 91 as being focused.

In another example, if the assembled object is a text document including tables and the geometrical objects represent one or more elements within the tables, the user may use example embodiments of the present invention to choose a table, an element within the table, edit an element in the table, and/or request additional information regarding the element.

Example embodiments of the present invention may be implemented, in software, for example, as a web browser, or any other suitable computer program. For example, a program in accordance with one or more example embodiments of the present invention may be a computer program product causing a computer to execute one or more of the example methods described herein: a method for generating a grid, a method for navigating through an assembled object, and/or a combination thereof.

The computer program product may include a computer-readable medium having computer program logic or code portions embodied thereon for enabling a processor of the apparatus to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

These programs may also be provided in the form of an externally supplied propagated signal and/or a computer data signal (e.g., wireless or terrestrial) embodied in a carrier wave. The computer data signal embodying one or more instructions or functions of an example methodology may be carried on a carrier wave for transmission and/or reception by an entity that executes the instructions or functions of the example methodology. For example, the functions or instructions of the example embodiments may be implemented by processing one or more code segments of the carrier wave, for example, in a computer, where instructions or functions may be executed for generating a grid, navigating through an assembled object, and/or a combination of generating a grid and navigating through an assembled object, in accordance with the example embodiments described herein.

Further, such programs, when recorded on computer-readable storage media, may be readily stored and distributed. The storage medium, as it is read by a computer, may enable the generating of a grid, the navigating through an assembled object, and/or a combination of generating a grid and navigating through an assembled object, in accordance with the example embodiments described herein.

The example embodiments of the present invention being thus described, it will be obvious that the same may be varied in many ways. For example, the methods according to example embodiments of the present invention, may be implemented in hardware and/or software. The hardware/software implementations may include a combination of processor(s) and article(s) of manufacture. The article(s) of manufacture may further include storage media and executable computer program(s), for example, a web-browser.

The executable computer program(s) may include the instructions to perform the described operations or functions. The computer executable program(s) may also be provided as part of externally supplied propagated signal(s). Such variations are not to be regarded as departure from the spirit and scope of the example embodiments of the present invention, and all such modifications as would be obvious to one skilled in the art are intended to be included within the scope of the following claims.

In example embodiments of the present invention, the state of the navigation (e.g., an indication of the current position of focus) may not be the geometrical object of focus, but the number of the pane in focus and the previous pane numbers, which may have been visited. A choice of state may allow the retention of row and/or column, for example, while navigating through objects, which may exist in more than one pane.

In example embodiments of the present invention, an assembled object may include geometrical objects. The geometrical objects may be replace with geometrical representations (e.g., object rectangles), producing a modified assembled object. A grid may then be generated allowing a user to navigate through the assembled object using asymmetric decision rules, which may allow a user to reach all geometrical objects within the assembled object. Although the modified assembled object and the grid generated therefore have been illustrated in order to provide adequate discussions of the example embodiments of the present invention, it will be understood that only the assembled object and geometrical objects included therein may be visible to the user. That is, the modified assembled object and the grid may be hidden to the user.

In example embodiments of the present invention, a grid including panes may improve navigation and/or provide the user with an improved appearance, for example, while navigating between geometrical objects. Panes, as discussed herein, may refer to horizontal rows, vertical columns, intersecting horizontal rows and vertical columns, diagonal rows and/or columns, etc.

In example embodiments of the present invention, a single geometrical object may exist in a plurality of panes, which may improve navigation through an assembled object.

Example embodiments of the present invention, may allow a user to reach all, or substantially all, geometrical objects within an assembled object, which may provide an increased number of possible assembled objects.

Although example embodiments of the present invention have been described with regard to four-way navigation, it will be understood that example embodiments may include eight-way navigation based on eight different directional commands and decision rules in addition to those described above. An example embodiment of the method of navigation may receive commands from some eight-way navigation with eight distinguishable (e.g., mechanically distinguishable) directions or from a quantified direction from an analog (e.g., 0-360 degrees) directional device (e.g., a joystick).

Although example embodiments of the present invention have been described with regard to the generation of vertical and horizontal object rectangle lines, it will be understood that the term generating may also be construed as, for example, identifying. That is, the vertical and/or horizontal object rectangle lines may be identified, and may not necessarily be generated.

Example embodiments of the present invention being thus described, it will be obvious that the same may be varied in many ways. Such variations are not to be regarded as a departure from the invention, and all such modifications are intended to be included within the scope of the invention.

I claim:

1. A method for navigating through an assembled object, the method comprising:
identifying at least one object within the assembled object;
generating a grid including at least one pane, in which at least one of the at least one pane includes at least a portion of one of the at least one identified object;
storing location information associated with at least one of the at least one identified object or the grid; and
navigating through the assembled object based on the stored location information.

2. The method of claim 1, wherein the generation of the grid further includes,
generating and sequencing object rectangle lines based on a location of the at least one identified object, and
selecting at least one grid line for the grid from the object rectangle lines based on the sequence of the object rectangle lines.

3. The method of claim 2, wherein the sequence of object rectangle lines includes a sequence of vertical object rectangle lines and a sequence of horizontal object rectangle lines.

4. The method of claim 1, wherein the navigation through the assembled object further includes,
selecting a pane,
receiving a command, and
performing a designated operation based on the received command.

5. The method of claim 4, wherein the designated operation is at least one of shifting to another assembled object and shifting to another generated pane including at least a portion of an object within the assembled object.

6. The method of claim 4, wherein the received command is a directional command, and the performing of the designated operation is shifting focus to another generated pane.

7. The method of claim 6, wherein the designated operation further includes,
choosing a second generated pane to shift to based on at least one of stored location information, a previously visited pane, and a designated default directional movement.

8. The method of claim 1, wherein the assembled object is a web-page or Hyper Text Mark-up Language (HTML) document.

9. The method of claim 1, wherein the location information associated with the at least one identified object includes coordinate information for at least a portion of the at least one identified object.

10. The method of claim 1, wherein the location information associated with the grid includes a list of at least a portion of the at least one generated pane in the grid and an indication of the presence or absence of an object within the at least one generated pane included in the list.

11. A method for navigating through an assembled object, the method comprising:
identifying at least one object within the assembled object;
replacing at least one of the at least one identified object with a generated geometrical representation;
generating a grid including at least one pane, in which at least one of the at least one pane includes at least a portion of one of the at least one geometrical representation; and
storing location information associated with at least one of the at least one geometrical representation or grid; and
navigating through the assembled object based on the stored location information.

12. The method of claim 11, wherein the at least one identified object, which is replaced, is a non-rectangular object.

13. The method of claim 11, wherein the geometrical representation is an object rectangle.

14. The method of claim 11, wherein the assembled object is a web-page or Hyper Text Mark-up Language (HTML) document.

15. The method of claim 12, wherein the generation of the grid further includes,
generating and sequencing object rectangle lines based on locations of the at least one identified object, and
selecting at least one grid line for the grid from the object rectangle lines based on the sequence of the object rectangle lines.

16. The method of claim 15, wherein the sequence of object rectangle lines includes a sequence of vertical object rectangle lines and a sequence of horizontal object rectangle lines.

17. The method of claim 11, wherein the navigation through the assembled object further includes,
selecting a pane,
receiving a command, and
performing a designated operation based on the received command.

18. The method of claim 17, wherein the designated operation is at least one of shifting to another assembled object and shifting to another generated pane including an a geometrical representation.

19. The method of claim 16, wherein the received command is a directional command, and the performing of the designated operation is shifting focus to another generated pane.

20. The method of claim 16, wherein the designated operation further includes,
choosing a second generated pane to shift to based on at least one of stored location information, a previously visited pane, and a designated default directional movement.

21. The method of claim 11, wherein the location information associated with the at least one geometrical representation includes coordinate information for at least a portion of the at least one geometrical representation.

22. The method of claim 11, wherein the location information associated with the grid includes a list of at least a portion of the at least one generated pane in the grid and an indication of the presence or absence of a geometrical representation within the at least one generated pane included in the list.

23. A web-browser adapted to perform the method of claim 1.

24. A web-browser adapted to perform the method of claim 11.

25. A program storage device readable by a machine, and tangibly embodying a program of instructions executable by the machine to perform the method of claim 1.

26. A program storage device readable by a machine, and tangibly embodying a program of instructions executable by the machine to perform the method of claim 11.
